(19) United States
(12) Patent Application Publication
(10) Pub. No.: US 2017/0208604 A1
(43) Pub. Date: Jul. 20, 2017

(54) SMART HOME CONTROL SYSTEM AND METHOD

(71) Applicants: AMBIT MICROSYSTEMS (SHANGHAI) LTD., Shanghai (CN); HON HAI PRECISION INDUSTRY CO., LTD., New Taipei (TW)

(72) Inventor: TIEN-TING KUO, New Taipei (TW)

(21) Appl. No.: 15/008,719

(22) Filed: Jan. 28, 2016

(30) Foreign Application Priority Data
Jan. 16, 2016 (TW) 105101310

(51) Int. Cl. H04W 72/10; H04L 12/28; H04W 4/02

(52) U.S. Cl. CPC H04W 72/10; H04W 4/025; H04L 12/2803

(57) ABSTRACT

A smart home control system includes at least one terminal device configured to capture physical attribute information of a number of users, at least one home appliance, and a control server. The control server determines physical attribute parameters of the users and determines a state of the users. The control server determines a suitable environmental parameter range for each user, determines an overlapping range of the suitable environmental parameter ranges, and calculates a most suitable environmental parameter value according to the overlapping range. The control server determines whether any of the users have a priority ranking and calculates a priority environmental parameter value according to the user having the highest priority ranking.

### FIELD

The subject matter herein generally relates to a smart home control system and a method for controlling the smart home.

### BACKGROUND

Generally, a smart home controls various home appliances according to user input through a terminal device. When the smart home is controlled by more than one user, the smart home needs to determine which command to transmit to the home appliances.

### BRIEF DESCRIPTION OF THE DRAWINGS

Implementations of the present technology will now be described, by way of example only, with reference to the attached figures.

FIG. 1 is a diagrammatic view of an embodiment of a smart home control system.

FIG. 2 is a block diagram of an embodiment of a control server of the smart home control system.

FIG. 3 is a flowchart diagram of an embodiment of a method for implementing a smart home system.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

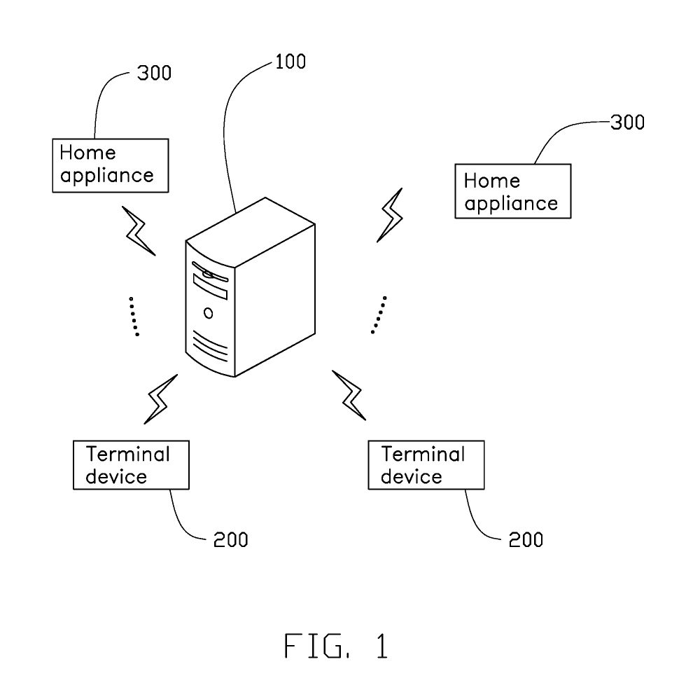

FIG. 1 illustrates an embodiment of a smart home system. The smart home system can include a control server 100, at least one terminal device coupled to the control server 100, and at least one home appliance 300 coupled to the control server 100. The control server 100 can be used to control the at least one home appliance 300 located in a designated environment, such as a home or an office.

Each terminal device 200 can capture a plurality of physical attribute information of one or more users. For example, the terminal device 200 can be a camera that can scan a face of a user. In at least one embodiment, the terminal device 200 can determine an identity of a user according to the physical attribute information. In another embodiment, the terminal device 200 can be an electronic device, such as a mobile phone, having positioning capabilities to determine whether the user is located in the designated environment.

In at least one embodiment, the terminal device 200 can be a single-function device, such as a pulse meter. In another embodiment, the terminal device 200 can be a multifunction device, such as a smart bracelet or a smart watch, to detect a plurality of physical attributes, such as a walking pace, a breathing pace, body temperature, pulse, or the like, and detect a state of the user, such as a sleeping state, an exercising state, or the like. The at least one home appliance 300 can be an air conditioner, a television, a smart door, or the like.

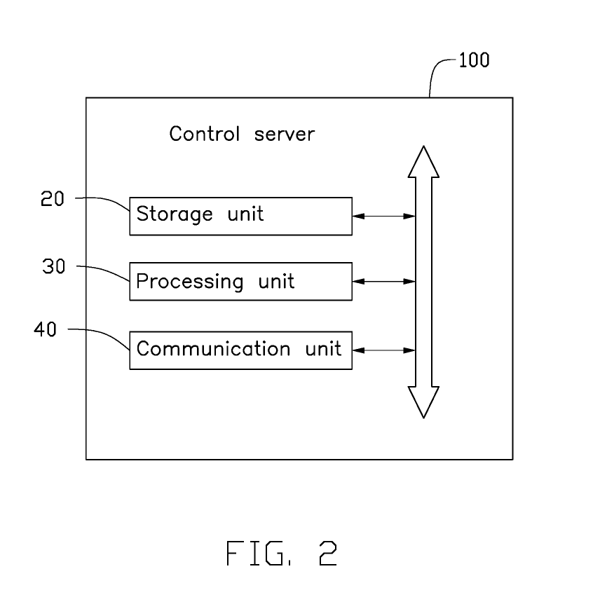

As illustrated in FIG. 2, the control server 100 can include a storage unit 20, a processing unit 30, and a communication unit 40. The storage unit 20 can be an internal storage unit of the control server 100. The storage unit 20 can also be an external storage unit such as a secure digital card, a smart media card, a flashcard, or the like. The storage unit 20, the processing unit 30, and the communication unit 40 can be electrically coupled to each other. The processing unit 30 can be a central processing unit of the control server 100 and can execute functions of the control server 100. The communication unit 40 can couple the control server 100 to the at least one terminal device 200 and the at least one home apparatus 300. In at least one embodiment, the communication unit 40 can couple the control server 100 to the at least one terminal device 200 and the at least one home apparatus 300 through BLUETOOTH, WIFI, Zigbee, or the like.

The control server 100 can obtain the physical attribute information captured by the terminal device 200 and determine physical attribute parameters and a state of the corresponding user.

In at least one embodiment, the storage unit 20 can store a plurality of physical attribute parameters and a priority ranking of a plurality of users. When the terminal device 200 collects the physical attribute information, the control server 100 can obtain the identity information of the corresponding user, the plurality of physical attribute parameters, and the priority ranking of the corresponding user from the storage unit 20. For example, the storage unit 20 can store a plurality of facial images of a plurality of users. When the terminal device 200 captures the facial image of a user, the control server 100 can verify the identity information of the user by comparing the captured facial image to the facial images stored in the storage unit 20. In at least one embodiment, the priority ranking of each user can be determined according to an order of the terminal device 200 capturing the physical attribute information for a first time. In another embodiment, the priority ranking can be determined by a user. In at least one embodiment, the storage unit 20 can save a health report of each user and determine the priority rankings according to the health reports.

In another embodiment, the storage unit 20 does not store the plurality of physical attribute parameters of the plurality of users. Instead, the terminal device 200 can determine the physical attribute parameters from the physical attribute information.

The control server 100 can obtain an environmental parameter range for each user according to each physical attribute parameters and the current state of the user and determine a suitable environmental parameter range for each user. The plurality of physical attribute parameters can include age, sex, blood pressure, horoscope sign, blood type, or the like. The state of the user can include a sleeping state, an exercising state, a resting state, or the like. The suitable environmental parameter range can be determined by research or be determined by statistical analysis, for example.

In an example scenario, the physical attribute parameters of a father of a home include male, 45 years old, O-type blood, and Leo sign. Each of the physical attribute parameters may correspond to a different environmental parameter range. For a male Leo of 40-45 years old having O-type blood between four o'clock and seven o'clock in Beijing in June, the suitable environmental parameter range with regards to temperature for the father may be between 16 degrees and 22 degrees Celsius.

The control server 100 can determine an overlapping range of the suitable environmental parameter ranges of a plurality of users. For example, in the example scenario, if the suitable environmental parameter range of a mother of the home is determined to be between 19 degrees and 25 degrees Celsius, the overlapping range between the father and the mother is 19 degrees to 22 degrees Celsius.

In at least one embodiment, the control server 100 can calculate, according to a predetermined algorithm, a most suitable environmental parameter value from the overlapping range. For example, in at least one embodiment, the predetermined algorithm calculates the most suitable environmental parameter value as the middle value (20.5 degrees Celsius) of the overlapping range.

The control server 100 can determine whether any of the users have a priority ranking. If there is no priority ranking of the users, the control server can transmit a command to the corresponding home apparatus to adjust the environmental parameter to the most suitable environmental parameter value. If there exists a priority ranking of the users, the control server obtains the highest priority ranking of the corresponding user and calculates a priority environmental parameter range. The control server 100 can calculate a priority environmental parameter value according to the priority environmental parameter range and the most suitable environmental parameter value.

The control server 100 determines whether the most suitable environmental parameter value falls within the priority environmental parameter range. If the most suitable environmental parameter value falls within the priority environmental parameter range, the control server 100 sets the most suitable environmental parameter value as the priority environmental parameter value. For example, if the mother has the highest priority, then the control server 100 sets the suitable environmental parameter range of the mother as the priority environmental parameter range. If the priority environmental parameter range for the mother is between 21 degrees and 27 degrees Celsius, then the most suitable environmental parameter value of 20.5 degrees Celsius falls within the range of 21 degrees and 27 degrees Celsius, so the control server sets the most suitable environmental parameter value as the priority environmental parameter value.

If the most suitable parameter value does not fall within the priority environmental parameter range, then the control server 100 calculates the priority environmental parameter value according to a predetermined algorithm. For example, if the mother has the highest priority and the priority environmental parameter range for the mother is between 23 degrees and 27 degrees Celsius, then the most suitable environmental parameter value of 20.5 degrees Celsius does not fall within the range of 23 degrees and 27 degrees Celsius, so the control server calculates the priority environmental parameter value according to a predetermined algorithm. In at least one embodiment, the predetermined algorithm calculates the priority environmental parameter value as the middle value (25 degrees Celsius) of the priority environmental parameter range. In another embodiment, the priority environmental parameter value is a random value within the priority environmental parameter range. In another embodiment, the priority environmental parameter value is calculated according to a golden ratio method.

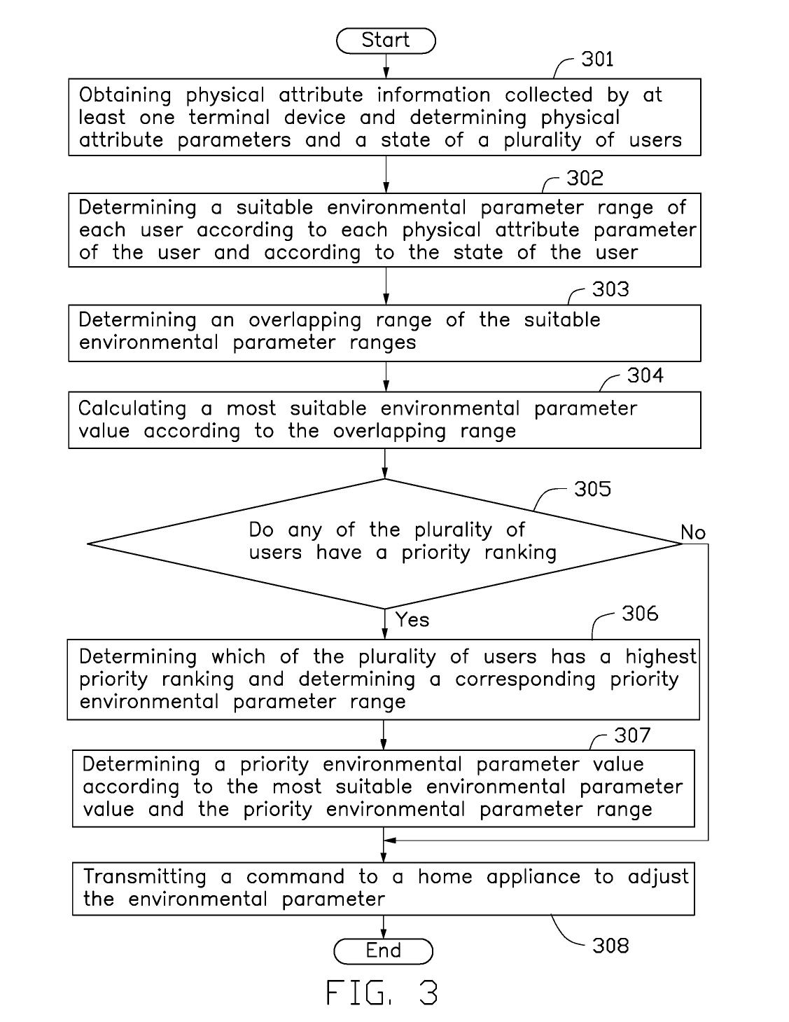

FIG. 3 illustrates a flowchart of an exemplary method for implementing a smart home system in a designated environment. The method is provided by way of example, as there are a variety of ways to carry out the method. The method described below can be carried out using the configurations illustrated in FIGS. 1-2, for example, and various elements of these figures are referenced in explaining the example method. Each block shown in FIG. 3 represents one or more processes, methods, or subroutines carried out in the example method. Furthermore, the illustrated order of blocks is by example only, and the order of the blocks can be changed. Additional blocks can be added or fewer blocks can be utilized, without departing from this disclosure. The example method can begin at block 301.

At block 301, a control server can obtain physical attribute information captured by at least one terminal device and determine physical attribute parameters and a state of one or more users according to the physical attribute information. In at least one embodiment, the control server can store a plurality of physical attribute parameters of a plurality of users. For example, the control server can store a plurality of facial images of a plurality of users. When the terminal device captures the facial image of a user, the control server can verify the identity information of the user by comparing the captured facial image to the facial images stored in the control server.

At block 302, the control server can determine an environmental parameter range for each user according to each physical attribute parameter of the user and according to the state of the user. The plurality of physical attribute parameters can include age, sex, blood pressure, horoscope sign, blood type, or the like. The state of the user can include a sleeping state, an exercising state, a resting state, or the like. The suitable environmental parameter range can be determined by research or be determined by statistical analysis, for example.

In an example scenario, the physical attribute parameters of a father of a home include male, 45 years old, O-type blood, and Leo sign. For a male Leo of 40-45 years old having O-type blood between four o'clock and seven o'clock in Beijing in June, the suitable environmental parameter range with regards to temperature for the father may be between 16 degrees and 22 degrees Celsius.

At block 303, the control server can determine an overlapping range of the suitable environmental parameter ranges of the plurality of users. For example, in the example scenario, if the suitable environmental parameter range of a mother of the home is determined to be between 19 degrees and 25 degrees Celsius, the overlapping range between the father and the mother is 19 degrees to 22 degrees Celsius.

At block 304, the control server can calculate a most suitable environmental parameter value according to the overlapping range. For example, in at least one embodiment, the predetermined algorithm calculates the most suitable environmental parameter value as the middle value (20.5 degrees Celsius) of the overlapping range.

At block 305, the control server can determine whether any of the plurality of users has a priority ranking. If any of the plurality of users has a priority ranking, block 306 is implemented. Otherwise, if there exists no priority ranking among the plurality of users, block 308 is implemented.

At block 306, the control server can determine which of the plurality of users has a highest priority ranking and determining a corresponding priority environmental parameter range. The control server obtains the highest priority ranking of the corresponding user and sets the suitable environmental parameter range of the user as the priority environmental parameter range.

At block 307, the control server can determine a priority environmental parameter value according to the most suitable environmental parameter value and the priority environmental parameter range. For example, if the mother has the highest priority and the priority environmental parameter range for the mother is between 21 degrees and 27 degrees Celsius, then the most suitable environmental parameter value of 20.5 degrees Celsius falls within the range of 21 degrees and 27 degrees Celsius, so the control server sets the most suitable environmental parameter value as the priority environmental parameter value.

If the most suitable parameter value does not fall within the priority environmental parameter range, then the control server calculates the priority environmental parameter value according to a predetermined algorithm. For example, if the mother has the highest priority and the priority environmental parameter range for the mother is between 23 degrees and 27 degrees Celsius, then the most suitable environmental parameter value of 20.5 degrees Celsius does not fall within the range of 23 degrees and 27 degrees Celsius, so the control server calculates the priority environmental parameter value according to a predetermined algorithm. In at least one embodiment, the predetermined algorithm calculates the priority environmental parameter value as the middle value (25 degrees Celsius) of the priority environmental parameter range. In another embodiment, the priority environmental parameter value is a random value within the priority environmental parameter range. In another embodiment, the priority environmental parameter value is calculated according to a golden ratio method.

At block 308, the control server can transmit a command to a home appliance to adjust the environmental parameter to either the most suitable environmental parameter value or the priority environmental parameter value.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A smart home control system operating in a designated environment, the smart home control system comprising:
at least one terminal device configured to capture physical attribute information of a plurality of users located in the designated environment;
at least one home appliance; and
a control server coupled to the at least one terminal device and the at least one home appliance, the control server configured to:
obtain the physical attribute information of the plurality of users and determine physical attribute parameters of the plurality of users;
determine a state of the plurality of users;
obtain, from a plurality of environmental parameter ranges stored in the control server, an environmental parameter range according to each physical attribute parameter of each user and the state of each user;
determine, according to the environmental parameter ranges, a suitable environmental parameter range for each user;
determine an overlapping range of the suitable environmental parameter ranges;
calculate, according to a predetermined algorithm, a most suitable environmental parameter value; and
transmit a command to the corresponding at least one home appliance to adjust the environmental parameter to the most suitable parameter value.

2. The smart home control system as in claim 1, wherein the control server is configured to:
determine whether any of the plurality of users has a priority ranking;
determine which of the plurality of users has a highest priority ranking and determine a corresponding priority environmental parameter range;
determine, according to the most suitable environmental parameter value and the priority environmental parameter range, a priority environmental parameter value; and
transmit a command to the corresponding at least one home appliance to adjust the environmental parameter to the priority environmental parameter value.

3. The smart home control system as in claim 2, wherein the control server determines the priority environmental parameter value by:
determining whether the most suitable environmental parameter value falls within the priority environmental parameter range;
determining, when the most suitable environmental parameter value falls within the priority environmental parameter range, the most suitable environmental parameter to be the priority environmental parameter value; and
calculating, according to a predetermined algorithm when the most suitable environmental parameter value does not fall within the priority environmental parameter range, a value that falls within the priority environmental parameter range.

4. The smart home control system as in claim 3, wherein the predetermined algorithm for determining the value that falls within the priority environmental parameter range is to set the middle value of the priority environmental parameter range as the priority environmental parameter value.

5. The smart home control system as in claim 1, wherein:
the control server comprises a storage unit, a processing unit, and a communication unit;
the storage unit is configured to store physical attribute parameters of a plurality of users and store priority ranking information of the plurality of users;
the communication unit is configured to couple the control server to the at least one terminal device and the at least one home appliance;
the control server verifies, according to the physical attribute information captured by the at least one terminal device, an identity of the plurality of users; and
the control server obtains the physical attribute parameters of the plurality of users once the identity of the plurality of users has been verified.

6. A method for implementing a smart home system in a designated environment, the method comprising:
obtaining, by a control server, physical attribute information of a plurality of users located in the designated environment and determining physical attribute parameters of the plurality of users, the physical attribute information captured by at least one terminal device coupled to the control server;
determining, by the control server, a state of the plurality of users;
obtaining, by the control server from a plurality of environmental parameter ranges stored in the control server, an environmental parameter range according to each physical attribute parameter of each user and the state of each user;
determining, by the control server according to the environmental parameter ranges, a suitable environmental parameter range for each user;
determining, by the control server, an overlapping range of the suitable environmental parameter ranges and calculating, according to a predetermined algorithm, a most suitable environmental parameter value; and
transmitting, by the control server, a command to the corresponding at least one home appliance to adjust the environmental parameter to the most suitable parameter value.

7. The method as in claim 6 comprising:
determining, by the control server, whether any of the plurality of users has a priority ranking;
determining, by the control server, which of the plurality of users has a highest priority ranking and determining a corresponding priority environmental parameter range;
determining, by the control server, according to the most suitable environmental parameter value and the priority environmental parameter range, a priority environmental parameter value; and
transmitting, by the control server, a command to the corresponding at least one home appliance to adjust the environmental parameter to the priority environmental parameter value.

8. The method as in claim 7, wherein the control server determines the priority environmental parameter value by:
determining whether the most suitable environmental parameter value falls within the priority environmental parameter range;
determining, when the most suitable environmental parameter value falls within the priority environmental parameter range, the most suitable environmental parameter to be the priority environmental parameter value; and
calculating, according to a predetermined algorithm when the most suitable environmental parameter value does not fall within the priority environmental parameter range, a value that falls within the priority environmental parameter range.

9. The method as in claim 8, wherein the predetermined algorithm for determining the value that falls within the priority environmental parameter range is to set the middle value of the priority environmental parameter range as the priority environmental parameter value.

10. The method as in claim 9, wherein:
the control server stores physical attribute parameters of a plurality of users and stores priority ranking information of the plurality of users;
the control server verifies, according to the physical attribute information captured by the at least one terminal device, an identity of the plurality of users; and
the control server obtains the physical attribute parameters of the plurality of users once the identity of the plurality of users has been verified.
